(19) United States
(12) Patent Application Publication
(10) Pub. No.: US 2013/0265857 A1
(43) Pub. Date: Oct. 10, 2013

(54) Device Association

(71) Applicant: MICROSOFT CORPORATION, Redmond, WA (US)

(72) Inventors: Christopher James Foulds, Cambridgeshire (GB); Kaido Kert, San Francisco, CA (US); Matthew T. Kaufman, Bonny Doon, CA (US)

(73) Assignee: Microsoft Corporation, Redmond, WA (US)

(21) Appl. No.: 13/828,717

(22) Filed: Mar. 14, 2013

Related U.S. Application Data
(63) Continuation-in-part of application No. 13/293,245, filed on Nov. 10, 2011.

(51) Int. Cl. G08C 23/02

(52) U.S. Cl. CPC G08C 23/02
USPC 367/199

(57) ABSTRACT

A method of associating a first device with a second device is disclosed. The first device through its speaker broadcasts a request for association using an audio signal. The broadcasted audio signal is received by the second device through its microphone. The first and second devices then cooperatively verifies a security code and upon a successful verification of the security code, the first and the second devices are enabled to communicate with each other.

### RELATED APPLICATIONS

This application is a continuation-in-part of and claims priority under 35 U.S.C. §120 to U.S. patent application Ser. No. 13/293,245, filed on Nov. 10, 2011, the disclosure of which is incorporated by reference herein in its entirety.

### BACKGROUND

### Background

Typically, electronic devices are paired using the Bluetooth™ technology. The term “pairing” means that two devices exchange some data to agree to work together to provide a predefined function. For example, a Bluetooth™ enabled mobile phone may be paired with a Bluetooth™ headset and upon a successful pairing, the headset provides speakers and microphone to the mobile phone.

There are many issues with the above stated method of pairing or associating two or more devices. First, a special hardware is needed at both ends to effect such pairing. Second, such pairing can only be used for prewired specific functions based on configured profiles. Also, the Bluetooth™ signals have wider range, hence, without a proper security, unintended pairing may occur. Another issue with the Bluetooth pairing is that the paired devices must stay within a physical proximity to each other after the pairing. Moreover, having extra hardware in devices can put more stress on device batteries.

### SUMMARY

In one embodiment, a method of associating a first device with a second device is disclosed. The first device through its speaker broadcasts a request for association using an audio signal. The broadcasted audio signal is received by the second device through its microphone. The first and second devices then cooperatively verify a security code and upon a successful verification of the security code, the first and the second devices are enabled to communicate with each other.

In another embodiment, a computer readable storage medium containing programming instructions for associating a first device and a second device, the programming instructions includes programming instructions for receiving, via a microphone, a request for association sent using an audio signal from another device. The request includes an audio signal that is outputted from a speaker of the other device. Programming instructions for verifying a security code and programming instructions for enabling the first device and the second device to communicate with each other are also included.

In yet another embodiment, a system comprises a first device and a second device. The first device includes a speaker and the second device includes a microphone. The system further includes a modulator incorporated in the first device. The modulator is coupled to the speaker, wherein the modulator being configured to generate an audio signal; and a demodulator incorporated in the second device. The demodulator is coupled to the microphone. The demodulator is configured to receive the audio signal. The first device is configured to include data in the audio signal. The data is encoded using a frequency shift keying mechanism and the demodulator is configured to retrieved the data from the audio signal, wherein the data includes a request for association.

Other embodiments include, without limitation, a computer-readable storage medium that includes instructions that enable a processing unit to implement one or more aspects of the disclosed methods as well as a system configured to implement one or more aspects of the disclosed methods.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only typical embodiments and are therefore not to be considered limiting of its scope, for the claimed subject matter may admit to other equally effective embodiments.

FIG. 1 illustrates a logical diagram of two devices, according to one embodiment.

FIG. 2 is a schematic diagram of associating two devices that are connected to a server, according to one embodiment.

FIG. 3 illustrates an example process of associating two devices, according to one embodiment.

FIG. 4 is an example activity diagram in accordance with one or more embodiments.

### DETAILED DESCRIPTION

In the following description, numerous specific details are set forth to provide a more thorough understanding of the described embodiments. However, it will be apparent to one of skill in the art that various embodiments may be practiced without one or more of these specific details. In other instances, well-known features have not been described in order to avoid obscuring the description.

Reference throughout this disclosure to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Frequency-shift keying (FSK) is a method of encoding digital signals and transmitting the encoded signals as analog signals. The two binary states (i.e., logic 0 and logic 1) are represented by analog waveforms for different frequencies. FSK is often used to transmit low-speed binary data over wireline and wireless links.

Minimum shift keying (MSK) is an efficient form of FSK. In MSK, the difference between the higher and lower frequency is identical to half of the bit rate. Consequently, the waveforms used to represent a 0 and a 1 bit differ by exactly half a carrier period.

Audio FSK is a modulation technique by which digital data is represented by changes in the frequency and an audio tone, yielding an encoded signal suitable for transmission via radio. Normally, the transmitted audio alternates between two tones, one represents a binary one and the other represents a binary zero. There are some other types of special FSK techniques based on the basic FSK principles. The Dual-tone multi-frequency signaling (DTMF) modulation techniques may also be used instead of or in conjunction with the FSK techniques. DTMF is typically used for telecommunication signaling over analog telephone lines in the voice-frequency band between telephone handsets and other communications devices and the switching center.

There are many other modulation techniques available to encode a digital signal in a voice signal. A person skilled in the art would realize that the embodiments described herein can be implemented using any other modulation technique so long as the modulation technique provides encoding coded data in audio signals. Various embodiments can also be implemented without using modulation techniques.

Typically, the process of pairing of two devices using the Bluetooth protocol initiates with a discovery process, which involves one device broadcasting the device identity using a low powered signal transmission. The other device then contacts the first device using the broadcasted information and the devices typically synchronize frequency and clocks and a communication channel is established between the two devices. Subsequently, typically upon entering a security key for the first device in the second device, the pairing is confirmed. The Bluetooth standard defines a certain number of application profiles in order to define which kinds of services are offered by a Bluetooth device. Even though one device can support multiple applications, these applications must be prewired and preconfigured in the device. For example, a Bluetooth™ wireless headset may only act as a headset because the device is prewired with a particular type of Bluetooth profile.

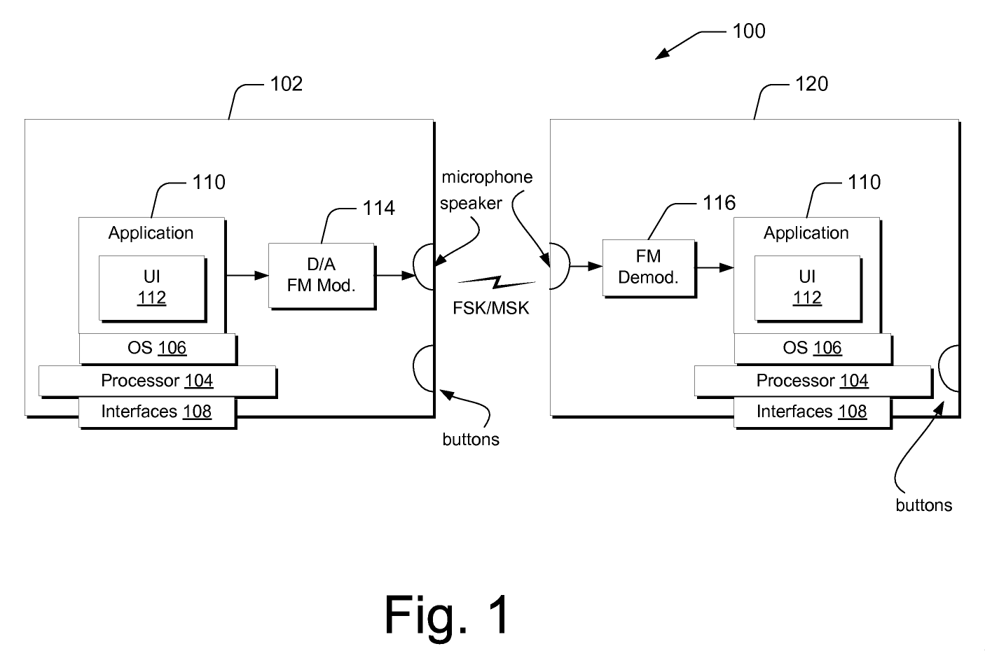

FIG. 1 illustrates a logical view of a system 100 including two devices 102, 120. In one example, the device 120 includes a microphone and the device 102 includes a speaker. The device 102 and the device 120 may also include a speaker and a microphone, respectively. It may be noted that a speaker and a microphone are staple components of a typical mobile communication or computing device. The device 102 includes an application 110 that may be embedded in hardware or may be a software application that runs within an operating system (OS) 106 and is executable by a processor 104 of the device 102. Other well-known components (e.g. memory, etc.) of the two devices have been omitted from FIG. 1 for the sake of clarity.

The device 120 also includes an application. The application in the device 120 may be a copy of the application 110 of the device 102. In another embodiment, the application in the device 120 may be a different application. In one embodiment, the application in the device 120 may be any application so long as the application in the device 120 complies with the data transport protocol of the application 110 in the device 102. The data transport protocol may be any communication protocol based on standard data transmission protocols such as TCP, UDP, etc. This data transport protocol is used by the device 102 to communicate data with the device 120. The device 102 and the device 120 may include an interface layer 108, for example to connect to a network such as the Internet.

In the device 102, the application 110 is coupled to a digital-to-analog (D/A) converter and a FM modulator 114. It may be noted that the D/A converter and/or FM modulator may be implemented in hardware or these modules may also be a part of the application 110. Alternatively, the D/A converter and/or FM modulator may be implemented as software drivers and services running in the OS 106. The D/A converter converts the binary data that the application 110 wants to transmit into analog signals. The FM modulator encodes the data to produce a FSK signal. The FSK signal is then outputted to the speaker of the device 102. Note that other techniques, which are well known to a person skilled in the art, may be used to convert the binary data produced by the application 110 to an FSK signal.

In the device 120, the application 110 (which may or may not be the same as the application 110 of the device 102) is coupled to a FM demodulator 116, which in turn is coupled to the microphone of the device 120. It should be noted that the device 120 may also include a D/A converter and/or a FM modulator and likewise the device 102 may include a FM demodulator.

The OS 106 is a general purpose operating system such as Android™, iOS™, Windows™ Mobile, WebOS™, Linux™, Windows™, etc. Although it is not shown, the OS 106 may include necessary drivers for network interface, sound, and other hardware such as FM modulator/demodulator, and other hardware components that are necessary to operate the device 102 and the device 120.

As noted above, a typical mobile device or computing device may not need any extra hardware (such as FM modulator, FM demodulator, D/A converter, etc.) in order to practice the embodiments as described herein because such functionality may be implemented in software itself. For example, if a device wishes to associate with another device through the methods described herein, an application (e.g., the application 110) may be installed on the device. Software or hardware implementations of FM modulators, FM demodulator, D/A converter, etc. are well known in the art. Hence, such details are being omitted.

In one embodiment, the FM modulator and demodulator may be tuned to use above audible frequencies. If frequencies above (or below) audible frequencies are used, the choice of frequencies may depends on the speaker and microphone configurations because the device 102 and device 120 may have filtered installed to filter out the out of range frequencies. Further, RF frequencies may not be used because a RF signal may not be able to drive an audio speaker. Audible frequencies (including slightly higher frequencies, e.g., ultrasonic frequencies) may always be used because microphones and speakers are typically configured to work in these audible frequencies. In yet another embodiment, one set of frequencies may be used during the initial association and another set of frequencies frequencies may be used for subsequent data communication between the devices. It may be noted that even though FIG. 1 shows two devices, more than two devices may participate in the process of association of devices. In one embodiment, one device may act as a master device and all other associated devices will act as ancillary or add-on devices.

The application 110 may include a user interface (UI) 112. A user of the device 102 may use the UI 112 to instruct the device 102 to initiate the pairing or association process. In another embodiment, one or more buttons of the device 102 may be programmed to instruct the device 102 either directly or via the application 110 to initiate the association process. In one embodiment, the device 102 initiates the association process by broadcasting the identification of the device 102 using FSK/MSK. Any other type of audio signal may be used so long as the broadcasted signal can contain encoded identification of the device 102 and the broadcasted audio signal may be detected by the speaker of the device 120. In one embodiment, the IP address of the device 102 is used for the identification. In other embodiments, other attributes of the device 102 may be used so long as the device 102 can be found and communicated with using those attributes. Along with the identification, a random code may also be broadcasted by the device 102.

The broadcasted audio signal is received at the speakers of all other devices in the vicinity. The receiving devices may have an “always active” listener module to capture these broadcasted audio signals. Alternatively, the listener module may be turned on or off as and when desired. The listener module (which may be a part of the FM demodulator 116 module of the application 110) may include programming to distinguish broadcast audio signals for device association from other audio signals. For example, the broadcasted signal may include a flag or code to inform the receiving devices that the audio signal contains pertains to device association. In one embodiment, the strength of the audio signals is configured to have a short range. For example, the range may be limited to the dimensions of a typical office conference room.

During the association process, the device 102 may display a security code on the display of the device 102. The security code may be a text string, a numeric or alpha numeric code. In another embodiment, the device 102 may display a graphical representation (e.g., QR code, or bar code) of the security code. In yet another embodiment, the device 102 may display a graphics such a duck, a house, etc. In another embodiment, the security code may be given to the user of the device 120 privately orally or via a text message or an email, away from the public view.

In another embodiment, a user of the device 120 provides a special security code to the user of the device 102. This special security code is associated with the device 120. This security code is then entered into the device 102 and then this security code is transmitted to the device 120 along with the request for association. Upon a successful verification of the security code, the device 120 sends a success signal back to the device 102. The success signal may be sent in the same way as the request for association sent from the device 102.

When the device 120 receives the transmitted audio signal, the device 120's FM demodulator/data extractor extracts the identification of the device 102. In one embodiment, the user of the device 120 enters the security code displayed on the display of the device 102. If the device 102 displays an encoded graphics, the device 120 may use a built-in camera to scan the encoded graphics. If the device 102 displays other types of graphics, such as a duck, the user of the device 120 may enter the name of the object in the displayed graphics. It should be noted that unlike Bluetooth pairing mechanism, the above pairing mechanism described herein does include Bluetooth type discovery mechanism.

After the user of the device 120 enters the security code, in one embodiment, the device 120 encodes its own identification in a FSK/MSK signal and broadcasts, along with the security code entered by the user. The device 102 receives the data through the FSK signal and checks the security code. The association process concludes if the security code matches. The two devices may exchange more data to determine what functions need to be distributed between them. In one embodiment, the devices may be configured to skip the security mechanism. Alternatively, in another embodiment, the security code may be generated by the device 120 and the device 102 transmits this security code for verification by the device 120. Still further, both devices 102, 120 generate security codes that need to be verified through the above stated mechanism (e.g., the device 102 verifies the security code of the device 120 and vice versa).

In another embodiment, instead of broadcasting the FSK signal, the device 120 sends a response message through a network to which the both devices are connected, using the identification of the device 102. Hence, in this embodiment, only the device 102 uses the FSK signal to broadcast its identification. Any subsequent communication between the device 102 and the device 120 takes place using the network (e.g., the Internet).

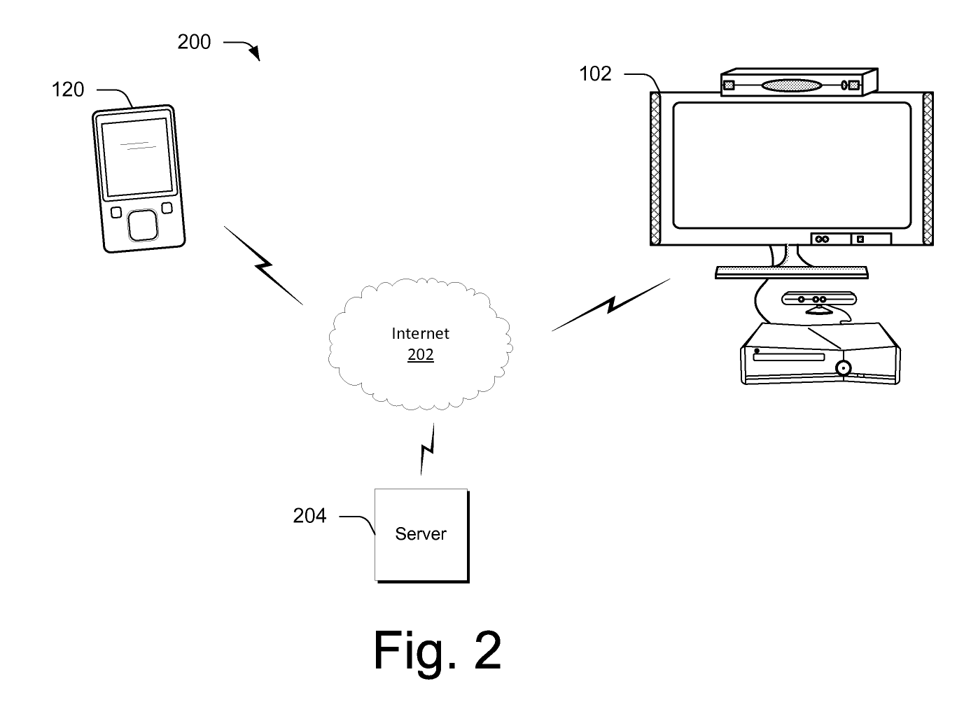

FIG. 2 describes another aspect of the association process 200. Accordingly, the device 102 broadcasts a FSK signal and the device 120 receives the broadcasted signal. The device 102 and the device 120 are connected to the Internet 202. Subsequently, the device 120 sends, via the Internet 202, a message that includes the identification of the device 120 and the security code entered by the user of the device 120, to the device 102.

In one embodiment, the device 102 and the device 120 include applications that are connected to a server 204. For example, the applications of the device 102 and the device 120 may be messaging clients and the server 204 may be a messaging server through which the messaging clients connect to other messaging clients. Upon conclusion of the initial handshake as described above, the applications in the device 102 and the device 120 may communicate with the server 204 to cooperatively distribute the functionality between the two devices. For example, the device 102 may be in an active communication session with a third device and may wish to transfer the active session to the device 120. Alternatively, the device 102 may want to transfer the camera functions of the active session to the device 120 instead of transferring the entire active session to the device 102. In other words, the application 110 and the server 204 may be configured to provide various options to the devices after they associate with each other, without any need for prewiring the devices for particular usage.

In one embodiment, to reduce noise interference, the encoded data in the broadcasted signal further includes a special flag or code so that the application in the device 120 may distinguish the audio signals for initiating the device association from the device 102.

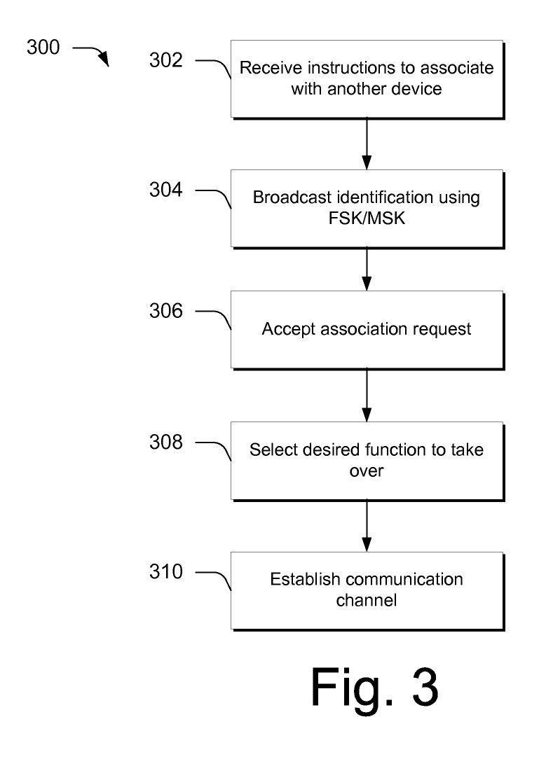

FIG. 3 illustrates a method 300 of associating two devices. At step 302, a first device receives instruction from a user to initiate the association process. The instructions may be received via a user interface or a preconfigured button of the first device. At step 304, the first device broadcasts its identification. The identification of the first device may be encoded in an audio signal using techniques such as FSK/CFSK/MSK, etc. The broadcast of the encoded data is performed through the standard speaker of the first device.

At step 306, a second device receives the broadcasted message via the microphone of the second device. The second device then decodes the encoded signal and extracts the identification of the first device. Optionally, the first device also displays a security code or security graphics. If the security code or security graphics is displayed, after extracting the identification of the first device, the second device requests its user to enter the security code in the second device. The second device then contacts the first device either using the identification of the first device or through a broadcast message. The response broadcast message or the message sent to the first device via the network includes the identification of the second device and optionally the security code of the first device.

At step 308, the first and the second devices negotiate distribution of desired functions between them. A user may also participate in the selection of desired functions for each of the two devices after the device association process. At optional step 310, a communication channel may be established between the two devices.

Using Audio Identifiers from Remote Sources

In the discussion that follows, it is to be appreciated and understood that any of the techniques described above can be utilized in connection with the approaches described below.

In one or more embodiments, security codes in the form of audio information that is utilized to establish device pairing can be obtained from one or more remote sources, such as a server or backend server. Any suitable type of audio information can be utilized. For example, a device can obtain, from the remote source, audio information in the form of raw audio and use that as a security code as described below. Alternately or additionally, the device can obtain, from the remote source, audio information in the form of a string of bits, and modulate the string of bits into an audio identifier which can be used to establish the device pairing.

In the illustrated and described approach, the remote source or backend server generates audio information that can be used as a security code to authenticate that the user of a particular device is physically located in the same place as another of the devices to which pairing is desired.

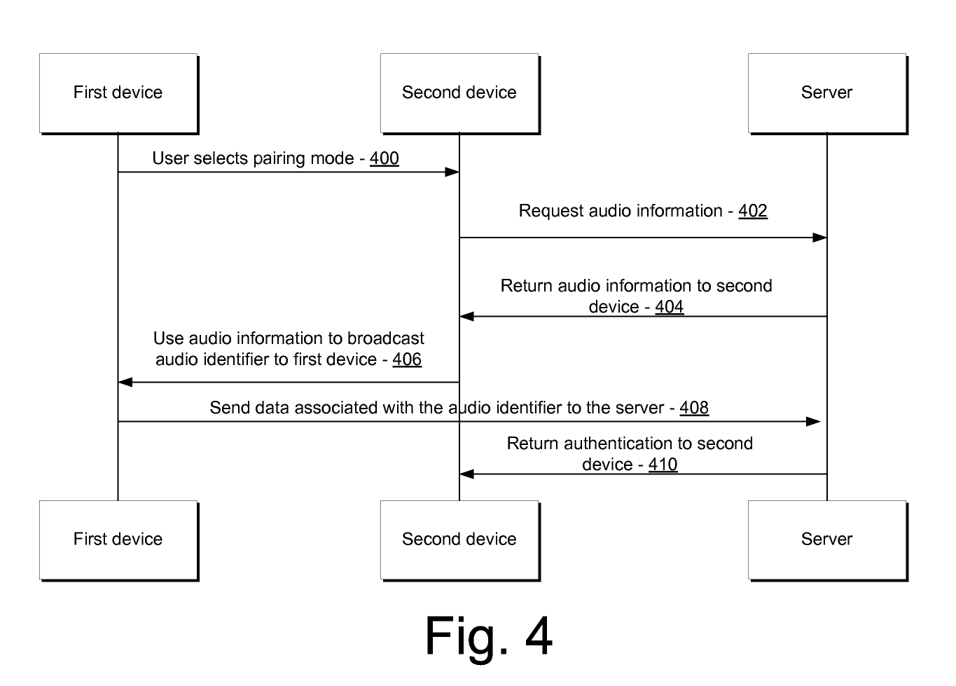

As an example consider FIG. 4, which illustrates an activity diagram that describes device pairing using audio identifiers in accordance with one or more embodiments. This example illustrates a first and second device. The first and second devices can be any suitable types of devices. For example, the first device can comprise a handheld device such as a phone. The second device can comprise a device such as a television. Initially, the user logs in to the first device and selects a pairing mode at 400. This can be done in any suitable way such as, for example, through a suitably configured user interface. Responsive to selecting the pairing mode, the first device can generate a pre-recorded signature tone that the second device recognizes. The second device recognizes this pre-recorded signature tone as a pairing initiation.

Next, and responsive to recognizing the pairing initiation, the second device requests audio information, at 402, from the remote source which, in this case, is a server. The audio information may or may not be unique audio information. The audio information can comprise any suitable type of audio information. For example, in at least some embodiments, the audio information can be a string of bits which is returned to the second device and subsequently encoded into an audio identifier or signal. Alternately or additionally, the information can comprise actual raw audio that is returned to the second device.

Responsive to receiving the request for the audio information, the server returns the audio information to the second device at 404. The second device now uses the audio information to broadcast, at 406, an audio identifier to the first device. This can be done in any suitable way. For example, in the event the audio information returned to the second device from the server is in the form of a string of bits, the second device can encode the string of bits into an audio identifier and broadcast the audio identifier to the first device. Alternately or additionally, in the event that the audio information returned to the second device from the server is in the form of audio data per se, the second device can broadcast the audio data to the first device.

The first device, upon receiving the broadcast audio identifier, can process the audio identifier and send data associated with the audio identifier, at 408, back to the server. In the event that the audio identifier is re-broadcast audio data per se, the first device can simply send data back to the server in the form of the audio data per se. Alternately or additionally, in the event that the audio identifier is encoded signal (such as an encoded string of bits), the first device can decode the signal to arrive at, e.g., the string of bits, and send that data back to the server.

When the server receives the data, it can confirm that the data matches and that the device pairing is authentic. Accordingly, the server can make note of the device pairing and return an authentication, at 410, to the second device.

Once the device pairing has been completed, the server can optionally store details of this device pairing so that in the future if other device is reset, for example in a meeting room, the pairing could be automatically completed upon the first stage of initiation from either end.

In the above example, the first device, e.g, the handheld device or phone, initiated the device pairing with the television. It is to be appreciated and understood, however, that device pairing can be initiated by the television or, in the above example, the second device.

In one or more other embodiments, devices can reside in a not paired/available state and advertise themselves to the backend server. For example, multiple devices such as televisions and other electronic devices can advertise themselves as available. Then, different devices, such as a handheld device, can query the backend servers for a list of devices with which it can connect based on network proximity identification. Once the user selects a particular available device from the list, the process can continue as described above. In these embodiments, the devices for pairing may reside on the same network.

While the forgoing is directed to specific embodiments, other and further embodiments may be devised without departing from the basic scope thereof. For example, aspects of the described embodiments may be implemented in hardware or software or in a combination of hardware and software. At least some embodiments may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions described above constitute embodiments of the present invention.

We claim:

1. A computer-implemented method comprising:
responsive to recognizing a pairing initiation by a first device, requesting audio information from a remote source;
receiving the audio information from the remote source and using the audio information to broadcast an audio identifier to the first device effective to enable the first device to return to the server to enable the server to authenticate a pairing between the first and second devices.

2. The computer-implemented method of claim 1, wherein using the audio information comprises encoding the audio information into the audio identifier.

3. The computer-implemented method of claim 1, wherein the audio information comprises the audio identifier.

4. The computer-implemented method of claim 1, wherein the first device comprises a handheld device.

5. The computer-implemented method of claim 1, wherein the second device comprises a television.

6. The computer-implemented method of claim 1, wherein using the audio information comprises encoding the audio information using a frequency shift keying (FSK) method.

7. The computer-implemented method of claim 1, wherein the first and second device are connected to a communication network.

8. The computer-implemented method of claim 1 further comprising enabling the first and second devices to communicate through audio signals using audible frequencies.

9. A computer-implemented method comprising:
generating, by a first device, a signature tone to enable a second device to recognize a pairing initiation between the first and second device;
receiving, from the second device, an audio identifier associated with the pairing initiation; and
processing the audio identifier and sending data associated with the audio identifier to a server effective to enable the server to return a pairing authentication to the second device.

10. The computer-implemented method of claim 9, wherein the audio identifier comprises an encoded signal and said processing comprises decoding the encoded signal.

11. The computer-implemented method of claim 9, wherein the audio identifier comprises a frequency shift keying (FSK)-encoded signal and said processing comprises decoding the encoded signal.

12. The computer-implemented method of claim 9, wherein the first device comprises a handheld device.

13. The computer-implemented method of claim 9, wherein the second device comprises a television.

14. The computer-implemented method of claim 9, wherein the first and second devices are connected to a communication network.

15. The computer-implemented method of claim 9, further comprising enabling the first and second devices to communicate through audio signals using audible frequencies.

16. A computer readable storage medium containing instructions for associating a handheld device and a television device, the program instructions comprising:
program instructions for requesting audio information from a remote source responsive to recognizing a pairing initiation by the handheld device;
programming instructions for receiving the audio information from the remote source and using the audio information to broadcast an audio identifier to the handheld device effective to enable the handheld device to return to the server to enable the server to authenticate a pairing between the handheld device and the television device.

17. The computer readable storage medium of claim 16, wherein using the audio information comprises encoding the audio information into the audio identifier.

18. The computer readable storage medium of claim 16, wherein the audio information comprises the audio identifier.

19. The computer readable storage medium of claim 16, wherein using the audio information comprises encoding the audio information using a frequency shift keying (FSK) method.

20. The computer readable storage medium of claim 16, wherein the first and second device are connected to a communication network.
